(19) United States
(12) Patent Application Publication
(10) Pub. No.: US 2014/0315490 A1
(43) Pub. Date: Oct. 23, 2014

(54) Enhancing efficiency of communication terminals using radio communication

(71) Applicants: Robbin Hughes, Plano, TX (US); Thomas O'Neill, La Jolla, CA (US); Prem Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Prem Jothipragasam Kumar, San Diego, CA (US); Ramesh Rajasekaran, Chennai (IN)

(21) Appl. No.: 13/868,611

(22) Filed: Apr. 23, 2013

(51) Int. Cl. H04W 4/00; H04W 72/04; H04W 52/02

(52) U.S. Cl. CPC H04W 4/008; H04W 52/0203; H04W 72/048
USPC 455/41.2; 455/509

(57) ABSTRACT

The proposed embodiment provides a method and system for enhancing efficiency of a communication terminal. The method includes configuring short-range communication and long-range communication in the communication terminal, receiving parameters associated with a node in a communication network, and switching among the short-range communication and the long-range communication within a data session based on the received parameters.

### TECHNICAL FIELD

The embodiments herein relate to enhancing efficiency of wireless communication terminals. More particularly, the present embodiment concerns a mechanism for reducing power consumption using both short-range and long-range communications in the wireless communication terminals.

### BACKGROUND

The utility of network devices is directly impacted by their operating lifetime before on-board batteries need to be replaced or recharged. In advanced network computing platforms including personal digital assistants, smart-phones, gateways, servers, routers, laptops, and the like, wireless communication system accounts for a major component of total power consumption due to the communication centric usage of the devices. Generally, these platforms are increasingly equipped with multiple radio interfaces to handle a variety of connections, ranging from Bluetooth for personal-area links, Wi-Fi for local-area connectivity, GPRS for wide-area data access, and the like.

Different systems and methods are proposed to reduce power consumption and enhance the efficiency of the devices. The existing systems and methods can allow the devices to connect with other network devices by creating a data session. For example, a Wi-Fi connection/link may serve the devices to keep connected with each other within the data session. This may be regardless of the Wi-Fi connection/link quality, congestion on the Wi-Fi connection/link, the battery power consumed, bandwidth, speed, range, and the like. Further, the existing systems and methods can allow the devices to switch between multiple radios interfaces after terminating/ending the current data session.

Though the existing system and methods are effective to a degree in reducing power consumption and enhancing the efficiency of the devices, they includes both advantages and disadvantages in terms of quality, security, congestion, power consumption, bandwidth, data sessions, spectrum loading, speed, range, and the like.

### BRIEF DESCRIPTION OF THE FIGURES

The embodiments herein will be better understood from the following detailed description with reference to the drawings, in which:

FIG. 1 illustrates generally, among other things, a typical communication system, according to embodiments described herein;

FIG. 2 illustrates generally, among other things, an exemplary wireless operational environment of the system as described in the FIG. 1, according to embodiments described herein;

FIG. 3 is a block diagram illustrating exemplary modules of communication terminal as described in the FIGS. 1 and 2, according to embodiments described herein;

FIG. 4 is a diagram illustrating an exemplary structural description of the communication terminal using multiple radios communications, according to embodiments disclosed herein; and

FIG. 5 is a flowchart illustrating generally a method for enhancing efficiency of the communication terminal, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for enhancing efficiency of a communication terminal. The communication terminal can be configured to include both short-range communication (e.g., Bluetooth and Ultra wideband) and long-range communications (e.g., Wi-Fi), such as to allow one or more nodes to communicate with each other over a communication network. The communication terminal receives different parameters associated with the nodes in the network. A connection between the communication terminal and the node is established by creating a data session. Further, the communication terminal measures the different parameter associated the nodes and switches among the short-range communications and long-range communications within the data session.

The proposed system and method is simple, reliable, and robust for lowering power consumption in the communication terminal by using both short-range and long-range communications. The appropriate short-range and long-range communication can be selected based on the parameters such as workload, bandwidth, congestion, communication link associated with node, the link quality, speed, range, sensitivity, session data, security, power consumption, spectrum loading, Geo data, and the like. The system can be used to keep others communications effectively turned off to save energy in the communication terminal. Wherever the nodes are in proximity to the terminal, the system can be used to inherently reduce the power consumption by using short-range communications instead of the long-range communications. Further for the nodes with low network-utilization, the system can use low-power/low-bandwidth interface and dynamically switch to the high-power/high-bandwidth interface whenever required. Furthermore, the system can be used to enhance the security by using short-range communication links (wherever necessary) between the communication terminal and the nodes, which are generally less visible than the long-range communication links. The system can be used to reduce the link loading by switching to appropriate communication channels. Furthermore, the proposed system and method can be implemented on the existing infrastructure and may not require extensive set-up or instrumentation.

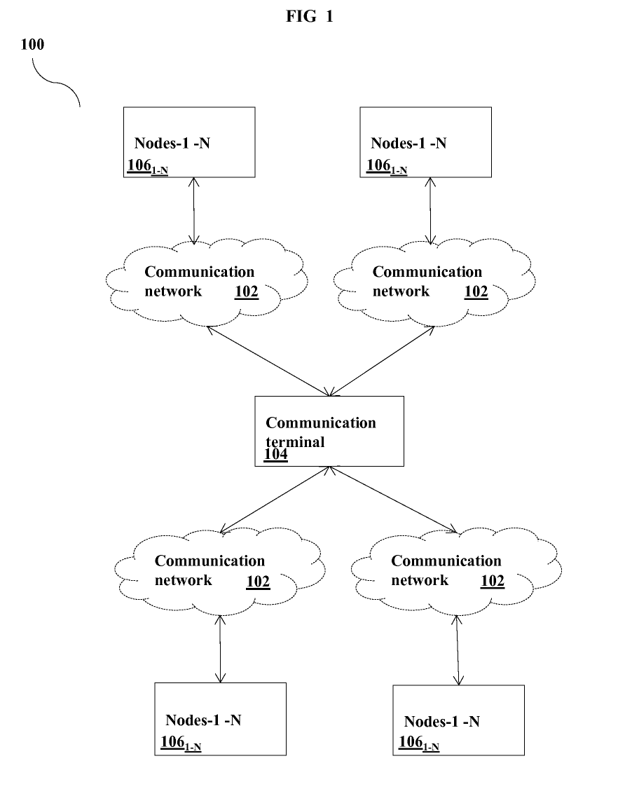

Referring now to the drawings, and more particularly to FIGS. 1 through 5, where similar reference characters denote corresponding features consistently throughout the figures, there are shown embodiments.

FIG. 1 illustrates generally, among other things, a typical communication system 100, according to embodiments described herein. The system 100 includes one or more communication network(s) 102, each connected by means of a communication terminal 104 (a gateway) to another network. In an embodiment, the communication network(s) 102 described herein can be a wireless communication network, a wire line communication network, or a combination thereof. Each communication network 102 may provide different advantages in terms of regarding speed, range, quality, security, cost, reliability, and the like. In an embodiment, the communication terminal 104 described herein can be for example, but not limited to, a gateway device, router, hub, computer, laptop, wireless electronic device, personal digital assistance, smart phone, and the like. In an embodiment, each communication network 102 can include one or more nodes 106_{1-N} (here after node(s) 106), each communicating wired or wirelessly with the terminal(s) 104 within a coverage area. In an embodiment, the node(s) 106 described herein can include for example, but not limited to, a gateway device, router, hub, computer, laptop, wireless electronic device, personal digital assistance, smart phone, and the like.

Further, the terminal 104 can be configured to include both short-range communications (for example, Bluetooth or Ultra wideband communications) and long-range communications (for example, Wi-Fi or IEEE 802.11 standards) to communicate with the nodes 106. As the present embodiment does not relate to the architecture of the wired or wireless communication system, it is not discussed in more detail here.

In the communication system 100 as shown in the FIG. 1, the terminal(s) 104 can be configured to allow the nodes 106 to communicate with each other over the communication network(s) 102. The terminal 104 can be configured to measure different parameters associated with the nodes 106 to connect or switch among the appropriate short-range and long-range communication channels. Each node in the system 100 is configured to be associated with a number of corresponding parameters that can be tuned to affect the performance and responsiveness of the system 100. In an embodiment, the parameters described herein can include for example, but not limited to, workload, congestion, link quality, speed, range, security, error correction, power consumption, spectrum loading, and the like. Any changes in these parameters can affect the sensitivity and reliability of the system 100. The changes in the parameters may affect the performance of the terminal 104, which can ultimately affect the overall system 100 energy consumption. In the present embodiment, power consumption is decreased throughout the system 100 by using the appropriate short-range and long-range communications (wherever necessary) thereby turning off the other unused or inappropriate communications between the terminal(s) 104 and the node(s) 106.

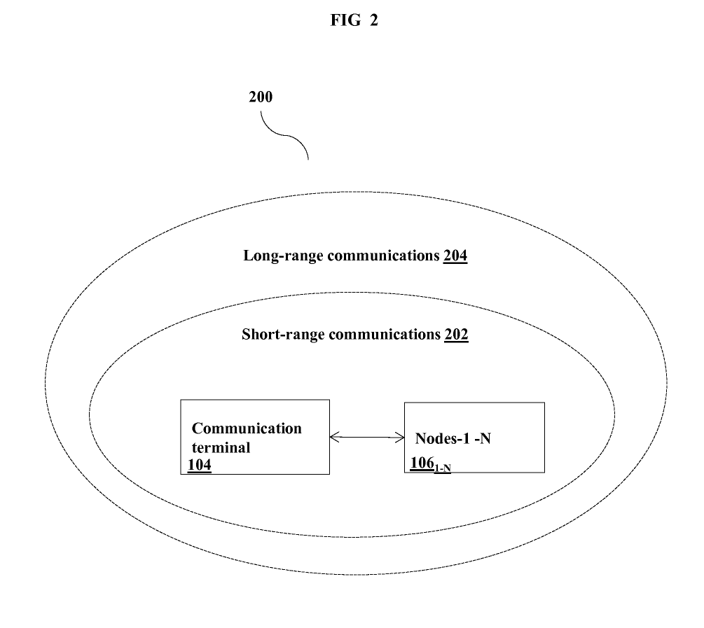

FIG. 2 illustrates generally, among other things, an exemplary wireless operational environment 200 of the system 100 as described in the FIG. 1, according to embodiments described herein. The terminal 104 can be configured to include both short-range communications 202 and long-range communications 204. In an embodiment, the short-range communication 202 can include applications for the sending and receiving data among the nodes 106. The short-range communications described herein can include for example, but not limited to, Bluetooth, near-field communication (NFC), ultra wideband (UWB), wireless local area network (WLAN), radio-frequency identification (RFID), ZigBee, or any other short-range communications.

The transmission range between two devices may be extended if both devices are capable of performing powered communications. In an embodiment, the long-range networks 204 can be used to provide virtually uninterrupted broaden communication coverage between the terminal 104 and the nodes 106. The long-range communications 204 described herein can include for example, but not limited to, global system for mobile communication (GSM), general packet radio service (GPRS), Wi-Fi, personal communications service (PCS), wideband code division multiple access (WCDMA), Worldwide interoperability for microwave access (WiMax), or any other long-range communications.

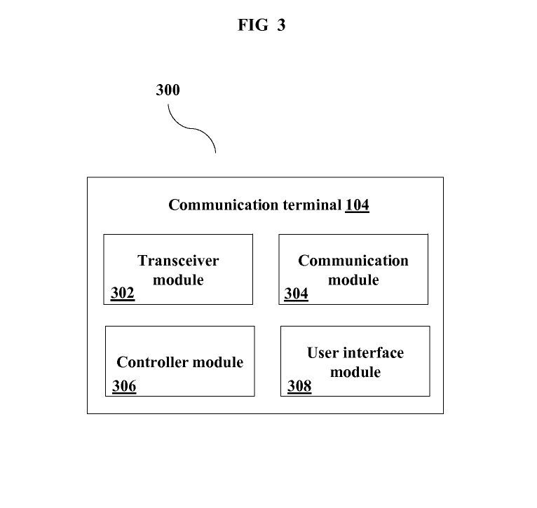

FIG. 3 is a block diagram illustrating exemplary modules 300 of the communication terminal 104 as described in the FIGS. 1 and 2, according to embodiments described herein. The communication terminal 104 can be configured to include a transceiver module 302, a communication module 304, a control module 306, and a user interface module 308.

In an embodiment, the transceiver module 302 can be configured to receive one or more parameters associated with the nodes 106. Each node in the system 100 can be associated with a number of corresponding parameters that can be adjusted to enhance the performance and responsiveness of the system 100. The transceiver module 302 can be configured to send request to each node in the communication network 102, such as to receive the associated parameters. In an embodiment, the parameters associated with the nodes 106 can include for example, but not limited to, workload, bandwidth, congestion, communication link associated with node, the link quality, speed, range, sensitivity, session data, security, power consumption, spectrum loading, Geo data, and the like. Any changes in these parameters can affect the sensitivity and reliability of the system 100. Further, the changes in the parameters can affect the performance of the terminal 104, which can ultimately affect the overall system 100 energy consumption.

In an embodiment, receiving parameters associated with the nodes 106 can involve privacy concerns, such as transmitting the information of the nodes 106 over the communication network 102 (or any third-party applications, devices, and networks). Options are available to address privacy concerns. The options may include that an administrator or security applications may be chosen to opt-in to participate or to opt-out to not participate in monitoring, measuring, and sharing of the parameters associated with the nodes 106.

In an embodiment, the communication module 304 can be configured to provide both the short-range communications and the long-range communications. The communication module 304 can be configured to allow the nodes 106 to use both local and long distance sources, and transmit data among each other within the transmission range. The short-range or long-range communications can be selected by the terminal 104 based on the received parameters associated with the nodes 106.

In an embodiment, the control module 306 can be configured to establish a connection between the terminal 104 and the node(s) 106 by creating a data session. The control module 306 can measure the parameters associated with the node 106 and create appropriate connections between the terminal 104 and the node 106. The control module 306, in communication with the transceiver module 202, can be configured to analyze the received parameters and select the appropriate short-range or long-range communication for the node 106.

Further, the control module 106 can be configured to constantly monitor and analyze the parameters of the node 106 and switches between the short-range communication and long-range communication. For example, if a node 106 is accessing a Wi-Fi communication link and remotely moving from one place to another then the system 100 creates a data session between the terminal 104 (using a Wi-Fi communication) and the node 106. The system 100 constantly monitors the node parameters and switches from the Wi-Fi to the Bluetooth communication upon detecting that the node is within the range of the Bluetooth communication and can be better served on reduced power using the Bluetooth communication. The terminal 104 can dynamically switches from the Wi-Fi connection/link to a Bluetooth connection/link. Unlike the existing systems, the terminal 104 can be configured to dynamically switch the communications link/channel within (or in the middle of) the data session. The controller module 306 can be configured to dynamically modify the current data session upon switching the communication link/channel thereby providing uninterrupted service to the nodes 106 and enhancing the efficiency of the terminal 104. Whenever the node 106 is in proximity to the terminal 104, the terminal 104 can switch from the long-range communication to the short-range communication for inherently reducing the power consumption. Consequently, the terminal 104 can be configured to turn-off the Wi-Fi communications when not in use to save the power of the terminal 104.

Another significant difference between the short-range communication (for e.g., Bluetooth) and long-range communication (for e.g., Wi-Fi) is the coverage range. In an example, the expected communication may ranges from 100-120 m for Wi-Fi and 10-12 m for Bluetooth. Both the radio communications can include significantly different transfer power to support communications at these distances. Such distance between the terminal 104 and the nodes 106 can significantly affect the system 100 performance in terms of throughput, bandwidth, congestion, speed, power consumption, security, reliability, data session, and the like.

Furthermore, in an embodiment, the control module 106 switches among the short-range communications and/or the long-range communications based on the parameters of the node 106. For example, if the node 106 is using a short-range communication channel such as a Bluetooth communication channel and the communication terminal 104 determines that the node 106 can be better served with even reduced power using a ZigBee communication channel then the terminal 104 can dynamically switch from the Bluetooth communication channel to the ZigBee communication channel. The controller module 306 can be configured to dynamically modify the current Bluetooth session data upon switching the communication link/channel, thereby providing uninterrupted service and enhancing the efficiency of the terminal 104. The session data can be modified in a way that it may be compactable to allow ZigBee communication between the terminal 104 and the node 106.

Furthermore, the control module 206 can be configured to include seamless switching mechanism that uses the existing short or long-range communication data session between the terminal 104 and the nodes 106 and provides uninterrupted services over the system 100. In an embodiment, the node 106 can be configured to automatically start a data session using a long or short-range communication and then communicate the associated parameters to the terminal 104, such as to dynamically perform a seamless switching to the appropriate short or long-range communication within (or in the middle of) the current data session.

Furthermore, the control module 306 can be configured to enhance the security of the system 100 by using the appropriate short-range communications links, which can be less visible than the long-range communication links in the communication network(s) 102. In an embodiment, for the nodes 106 with low network-utilization, the control module 306 can be configured to use low-power/low-bandwidth interface and dynamically switch to the high-power/high-bandwidth interface whenever required. For example, the control module 306 can measure and analyze the bandwidth parameter of the traffic going across the nodes 106, and dynamically trigger a switch when the measured bandwidth reaches a specified threshold. In an embodiment, the control module 306 can be configured to operate in a dual mode by communicating using multiple communication channels (such as both the short-range and the long-range communication channels) at substantially same time.

In an embodiment, the user interface module 308 can be configured to provide a graphical, visual, audible, tactile, and the like presentation of elements, such as to receive input from a user of the communication terminal 104. Further, the user interface module 308 can be configured to provide alerts, messages, notifications, or any other output information on the communication terminal 104 or the nodes 106. In an embodiment, the data received from the user may be parsed and interpreted by the control module 306 to accordingly perform or respond to the nodes 106. Furthermore, other nodes (such as node 106) present in the communication network(s) 102 can also send data or messages to the communication terminal 104, and the control module 306 can be configured to cause the data to be transferred to the user interface module 308.

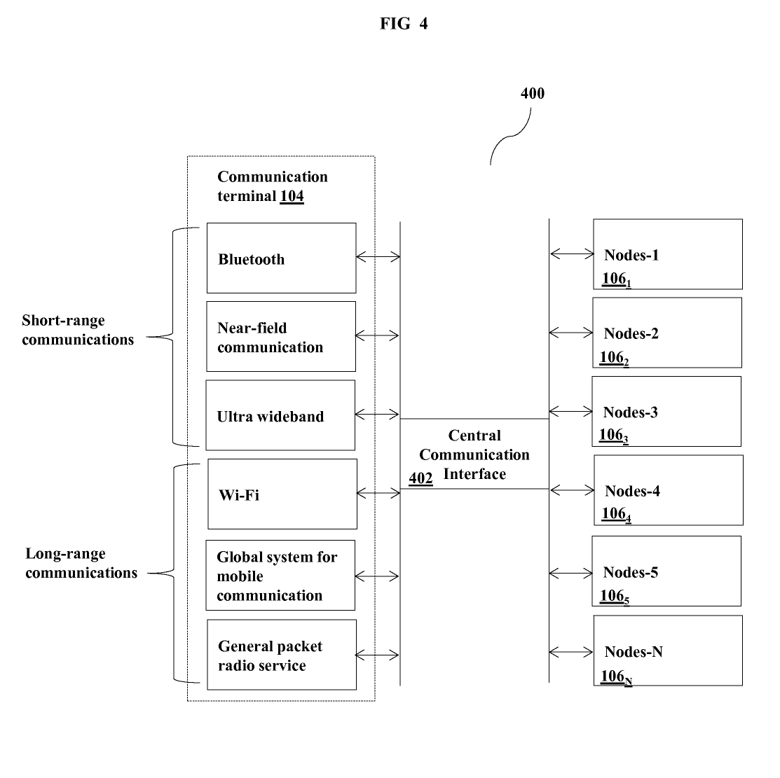

FIG. 4 is a diagram 400 illustrating an exemplary structural description of the communication terminal 104 using multi-radios communications, according to embodiments disclosed herein. In an embodiment, the communication terminal 104 can be configured to include a central communication interface 302 to virtually transfer information between the communication terminal 104 and the nodes 106. Exemplary short-range communications (for example, Bluetooth, UWB, and NFC) and long-range communications (for example, Wi-Fi, GSM, and GPRS) are shown in the FIG. 4. The communication terminal 104 can be configured to use the central communication interface 302 to connect or switch between the short-range and the long-range communications based on the parameters associated with the nodes 106, such as described in conjunction with the FIG. 3.

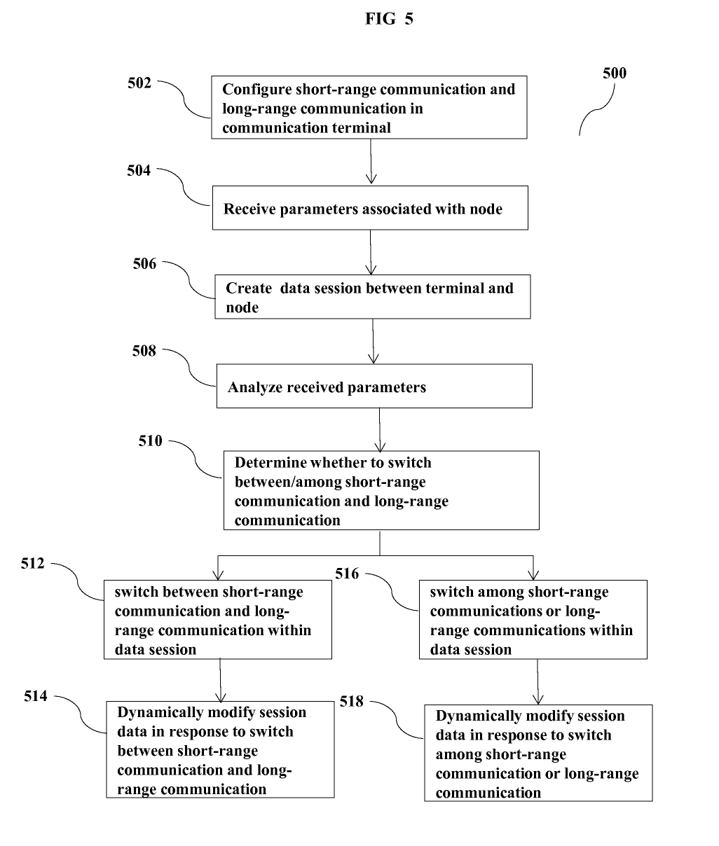

FIG. 5 is a flowchart illustrating generally a method 500 for enhancing efficiency of the communication terminal 104, according to embodiments disclosed herein. In an embodiment, at 502, the method 500 includes configuring the short-range communication and the long-range communication in the communication terminal 104. In an example, the method 500 allows the communication terminal 104 to include interfaces to both the short-range communication and long-range communication. In an example, the short-range communication can include Bluetooth, near-field communication (NFC), ultra wideband (UWB), wireless local area network (WLAN), radio-frequency identification (RFID), ZigBee, and the like. In an example, the long-range communications can include global system for mobile communication (GSM), general packet radio service (GPRS), Wi-Fi, personal communications service (PCS), wideband code division multiple access (WCDMA), Worldwide interoperability for microwave access (WiMax), and the like.

In an embodiment, at 504, the method 500 includes receiving parameters associated with the node(s) 106. In an example, the method 500 allows the communication terminal 104 to send request to each node in the communication network 102, such as to receive the associated parameters. The parameters described herein can include for example, but not limited to, workload, bandwidth, congestion, communication link associated with node, the link quality, speed, range, sensitivity, session data, security, power consumption, spectrum loading, Geo data, and any other parameter.

In an embodiment, at 506, the method 500 includes creating a data session between the communication terminal 104 and the node(s) 106. In an example, the method 500 allows the communication terminal 104 to create an appropriate data session based on the received parameters of the node(s) 106. In an example, the node 106 can automatically start a data session using a long or short-range communication and then communicate the associated parameters to the terminal 104, such as to dynamically switch to the appropriate short or long-range communication within (or in the middle of) the data session.

In an embodiment, at 508, the method 500 includes analyzing the received parameters associated with the node 106. In an example, the method 500 allows the communication terminal 104 to continuously monitor the parameters associated with the node 106. Any changes in these parameters can affect the sensitivity, reliability, and performance of the communication terminal 104, which can ultimately affect the overall power consumption of both the communication terminal 104 and the nodes 106.

In an embodiment, at 510, the method 500 includes determining whether to switch between/among the short-range communication and the long-range communication. In an example, the communication terminal 104 determines to switch between/among the short-range and long-range communication based on the analysis of the parameters associated with the node 106.

In an embodiment, at 512, the method 500 includes switching between the short-range communication and the long-range communication within the data session. In an example, the method 500 allows the communication terminal 104 to dynamically switch between the short-range and long-range communication within (or in the middle of) the data session in response to determining any change in the parameters of the node 106. For example, if the node 106 is using a Wi-Fi communication link and the terminal determines that the node 106 is in proximity (or within the coverage area of short-range communication such as Bluetooth) then the communication terminal 104 can dynamically switches from the Wi-Fi communication link to the Bluetooth communication link with the data session. As a result, the power consumption in both the communication terminal 104 and the node 106 can be inherently reduced by using the short-range communication instead of the long-range communication links. Further, in another example, if the workload and bandwidth parameters across the node 106 is going above or below a specific threshold level then the terminal 104 can dynamically switch the communication channel to ensure reliability, performance, and service to the node 106.

In an embodiment, at 514, the method 500 includes dynamically modifying the session data in response to switching between the short-range communication and the long-range communication. In an example, the method 500 allows the terminal 104 to automatically connect to the switched communication channel and modify the current session data, such as to provide uninterrupted service to the node 106 and enhance the efficiency of the terminal 104.

In an embodiment, at 516, the method 500 includes switching among the short-range communications or the long-range communications within the data session. The method 500 allows the communication terminal 104 to switch among the short-range communications or the long-range communications within the data session based on the parameters associated with the node(s) 106. For example, if the node 106 is using a short-range communication channel such as a Bluetooth communication channel and the communication terminal 104 determines that the node 106 can be better served with even reduced power using a ZigBee communication channel then the terminal 104 can dynamically switch from the Bluetooth communication channel to the ZigBee communication channel. Further, in an embodiment, the method 500 allows the terminal 104 to operate in a dual mode by communicating using multiple communication channels (such as both short-range and long-range communication channels) at substantially the same time.

In an embodiment, at 518, the method 500 includes dynamically modifying the session data in response to switching among the short-range communications or the long-range communications. In an example, the method 500 allows the terminal 104 to automatically connect to the switched communication channel and modify the current session data, such as to provide uninterrupted service to the node 106 and enhance the efficiency of the terminal 104.

The various steps, acts, blocks, units, and actions of the method 500 may be performed in the order presented, in a different order or simultaneously. Further, in some embodiments, some actions listed in the FIG. 5 may be omitted, added, or skipped without departing from the scope of the embodiment.

The operations, steps, blocks, units, and acts described with respect to the FIG. 5 are preferably automatic and may not require any type of user intervention. In this way, the system maintains a substantially up to date description of each node in the network.

The embodiments disclosed herein can be implemented through at least one software program running on at least one hardware device and performing network management functions to control the network elements. The network elements shown in FIGS. 1 through 5 include blocks which can be at least one of a hardware device, or a combination of hardware device and software module.

The embodiment disclosed herein specifies a system and method for automatically enhancing efficiency of a communication terminal. The mechanism allows dynamically switching among or between long-range communication and short-range communication in the middle of a data session based on different parameters associated with nodes in the network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for enhancing efficiency of a communication terminal, the method comprising:
configuring at least one of short-range communication and long-range communication in said communication terminal;
receiving at least one parameter associated with at least one node in a communication network; and
switching among at least one of said short-range communication and said long-range communication within a data session based on said at least one parameter associated with said at least one node.

2. The method of claim 1, wherein said data session is created between said communication terminal and said at least one node using at least one of said short-range communication and said long-range communication.

3. The method of claim 1, wherein said method further comprises dynamically modifying said session data in response to said switching among at least one of said short-range communication and said long-range communication.

4. The method of claim 1, wherein said short-range communication channel comprises at least one of a Bluetooth, near-field communication, ultra wideband, wireless local area network, radio-frequency identification, and ZigBee.

5. The method of claim 1, wherein said long-range communication comprises at least one of a global system for mobile communication, general packet radio service, Wi-Fi, personal communications service, wideband code division multiple access, and worldwide interoperability for microwave access.

6. The method of claim 1, wherein said at least one parameter associated with said at least one node comprises at least one of a power consumption, communication channel associated with node, said link quality, session data, workload, bandwidth, congestion, speed, range, security data, and Geo data.

7. The method of claim 1, wherein said method further comprises operating in a dual mode by using multiple communications at substantially same time.

8. The method of claim 1, wherein said method further comprises using a central communication interface to interface at least one of said short-range communication and said long-range communication with said at least one node.

9. The method of claim 1, wherein said method further comprises connecting said communication terminal and said at least one node within said data session using at least one of said short-range communication and said long-range communication.

10. The method of claim 9, wherein said connection is determined based on said at least one parameter associated with said at least one node.

11. The method of claim 9, wherein said method further comprises dynamically modifying said session data in response to said connection between said communication terminal and said at least one node.

12. The method of claim 1, wherein said method further comprises switching between said short-range communication and said long-range communication within said data session based on said at least one parameter associated with said at least one node.

13. The method of claim 12, wherein said method further comprises dynamically modifying said session data in response to said switching between said short-range communication and said long-range communication.

14. A system for enhancing efficiency of a communication terminal, the communication terminal comprising:
a communication module configured to provide at least one of short-range communication and long-range communication in said communication terminal;
a transceiver module configured to receive at least one parameter associated with at least one node in a communication network; and
a control module configured to switch among at least one of said short-range communication and said long-range communication within a data session based on said at least one parameter associated with said at least one node.

15. The system of claim 14, wherein said data session is created between said communication terminal and said at least one node using at least one of said short-range communication and said long-range communication.

16. The system of claim 14, wherein said control module is further configured to dynamically modify said session data in response to said switch among at least one of said short-range communication and said long-range communication.

17. The system of claim 14, wherein said short-range communication channel comprises at least one of a Bluetooth, near-field communication, ultra wideband, wireless local area network, radio-frequency identification, and ZigBee.

18. The system of claim 14, wherein said long-range communication comprises at least one of a global system for mobile communication, general packet radio service, Wi-Fi, personal communications service, wideband code division multiple access, and worldwide interoperability for microwave access.

19. The system of claim 14, wherein said at least one parameter associated with said at least one node comprises at least one of a power consumption, communication channel associated with node, said link quality, session data, workload, bandwidth, congestion, speed, range, security data, and Geo data.

20. The system of claim 14, wherein said control module is further configured to operate in a dual mode by using multiple communications at substantially same time.

21. The system of claim 14, wherein said control module is further configured to use a central communication interface to interface at least one of said short-range communication and said long-range communication with said at least one node.

22. The system of claim 14, wherein said control module is further configured to connect said communication terminal and said at least one node within said data session using at least one of said short-range communication and said long-range communication.

23. The system of claim 22, wherein said connection is determined based on said at least one parameter associated with said at least one node.

24. The system of claim 22, wherein said control module is further configured to dynamically modify said session data in response to said connection between said communication terminal and said at least one node.

25. The system of claim 14, wherein said control module is further configured to switch between said short-range communication and said long-range communication within said data session based on said at least one parameter associated with said at least one node.

26. The system of claim 25, wherein said control module is further configured to dynamically modify said session data in response to said switching between said short-range communication and said long-range communication.
